(19) United States
(12) Patent Application Publication
(10) Pub. No.: US 2010/0282656 A1
(43) Pub. Date: Nov. 11, 2010

(54) OSMOTIC BARRIER SYSTEM AND METHOD

(76) Inventors: Tzahi Y. Cath, Golden, CO (US); Amy E. Childress, Reno, NV (US)

Correspondence Address: UNR/DRI Technology Transfer Office, UNR-DRI Technology Transfer Office, Mail stop 321, 1664 N. Virginia St, Reno, NV, 89557, US

(21) Appl. No.: 12/774,508

(22) Filed: May 5, 2010

Related U.S. Application Data
(60) Provisional application No. 61/175,730, filed on May 5, 2009.

(51) Int. Cl. C02F 1/00

(52) U.S. Cl. 210/170.11

(57) ABSTRACT

In one embodiment, the present disclosure provides an osmotic barrier system that includes a production well, providing a source of saline water, and a source of feed water. An osmosis unit receives the feed water and saline water and osmotically dilutes the saline water with water from the feed water. Diluted saline water from the osmosis unit is injected into a recharge well located upstream from the production well. In another embodiment, the present disclosure provides a method of forming an osmotic barrier. A saline solution is obtained from a production well and passed to a draw side of an osmosis unit. A feed solution is passed onto a feed side of the osmosis unit. The saline solution is osmotically diluted with water from the feed solution and the diluted saline solution is provided to a recharge well located upstream from the production well.

### CROSS REFERENCE TO RELATED APPLICATION

This application claims the benefit of, and incorporates by reference, U.S. Provisional Patent Application No. 61/175,730, filed May 5, 2009.

### BACKGROUND

Seawater intrusion refers to the subsurface flow of seawater into fresh water aquifers. Seawater intrusion can be induced by natural processes or human activities. Seawater intrusion occurs when the groundwater level decreases or the seawater levels increase.

In many coastal areas, seawater intrusion occurs when fresh water is withdrawn from the coastal aquifer faster than it can be recharged with fresh water near a coastline. Seawater flows down gradient from the salty zone to the fresh water zone. Saltwater intrusion adversely affects the quality of groundwater at the pumping well sites, at other wells, and at undeveloped parts of the aquifer.

Many coastal areas in the United States, especially in heavily populated coastal cities, lose their groundwater sources due to decline in groundwater quality induced by seawater intrusion. During consecutive drought years in arid coastal areas, the situation is further aggravated due to the reliance on groundwater as the main water source.

### SUMMARY

In one embodiment, the present disclosure provides a system for forming an osmotic barrier, such as a barrier to eliminate or reduce saltwater encroachment into a freshwater aquifer. In some cases, the barrier achieves its effect using water pressure, such as hydrostatic pressure, to push salt water away from an aquifer.

Generally, the system includes a source of impaired water, an osmosis unit, particularly an engineered osmosis unit, a production well, and a recharge well. An engineered osmosis unit, in some configurations, includes a semipermeable membrane. In specific implementations, the system includes a pretreatment unit, which may be used to pretreat the impaired water before it enters the osmosis unit. In further aspects, the recharge well is one of an array of recharge wells. In another aspect, the production well is one of an array of production wells. In a specific example, the recharge well is one of an array of recharge wells and the production well is one of an array of production wells. In other implementations, the recharge wells are arranged parallel to a shoreline or to a saltwater encroachment front. The system includes a pressure exchanger, in some configurations.

In some embodiments, the system is configured to perform pressure retarded osmosis. In such cases, the system typically includes a generator, such as a turbogenerator, that can be used to produce electricity from pressure differences created by the osmosis unit.

An embodiment of a method according to the present disclosure forms an osmotic barrier between a first solution having a relatively high osmotic pressure or potential and a second solution having a relatively low osmotic pressure. The barrier is created by injecting a third solution between the first and second solutions. The third solution has an osmotic potential less than the first solution and greater than the second solution. The third solution, in one implementation, is prepared by osmotically diluting feed water, such as water from the first solution, with water from an impaired water, for example, water from the second solution.

In another implementation, salt-containing water is pumped out of a production or extraction well. The salt-containing water is passed into an osmosis unit, such as an engineered osmosis unit. An impaired water is also passed into the osmosis unit. In some examples, the impaired water is pretreated before being passed into the osmosis unit. In the osmosis unit, water from the impaired water flows through a membrane, such as a semipermeable membrane, into the salt-containing water, thus forming a diluted salt water stream. The diluted salt water stream is used as the third solution, as described above. In particular examples, the third solution is pumped into a recharge well, such as a recharge well feeding an area located between the production well and a water source to be protected from salt water encroachment.

According to yet another implementation, the system is operated using pressure retarded osmosis. At least a portion of the diluted salt water stream is passed into a generator, such as a turbogenerator. A portion of the diluted salt water stream is passed through a pressure exchanger. The portions of the diluted salt water stream are recombined, in more specific examples, and then injected into the recharge well. The generator produces electricity.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above. Additional features of the present disclosure are described in the appended claims.

### BRIEF DESCRIPTION OF THE DRAWINGS

Various embodiments are shown and described in connection with the following drawings in which:

FIG. 1 is a schematic diagram illustrating how salt water can encroach into a fresh water aquifer, particularly when fresh water is being extracted from the aquifer.

FIG. 2 is a schematic diagram illustrating an osmotic barrier layer system and process according to an embodiment of the present disclosure.

FIG. 3 is a detailed schematic diagram illustrating an osmotic barrier layer system and process according to an embodiment of the present disclosure.

FIG. 4 is a schematic diagram illustrating an osmotic barrier layer system having a plurality of production wells and a plurality of recharge wells.

FIG. 5 is a flowchart illustrating a method of forming an osmotic barrier according to an embodiment of the present disclosure.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. Although methods and materials similar or equivalent to those described herein can be used in the practice or testing of the present disclosure, suitable methods and materials are described herein. The disclosed materials, methods, and examples are illustrative only and not intended to be limiting.

In various embodiments, the present disclosure provides a method and system useable to form a barrier between a first solution having a relatively high osmotic pressure or potential and a second solution having a relatively low osmotic pressure. The barrier is formed by osmotically diluting a solution, such as the first solution, and injecting the diluted solution between the first and second solutions. The dilution uses, in some examples, an impaired water as a feed water source. In a specific example, the method and system use osmotically-driven membrane processes, such as using engineered osmosis units, to passively dilute saline groundwater, such as in aquifers affected by saltwater intrusion.

For purposes of the present disclosure, osmosis is defined as the net movement of material across a selectively permeable membrane driven by a difference in chemical potential across the membrane. In a particular example, a selectively permeable membrane allows passage of water, but rejects solute molecules or ions.

Some implementations of the present disclosure employ pressure pressure-retarded osmosis (PRO). PRO uses osmotic pressure differences between feed and draw solutions to convert osmotic pressure into hydrostatic pressure, which can be put to beneficial use. In a particular example, PRO is use to harness the osmotic pressure differences between a saline water or concentrated brine and fresh water to pressurize the saline stream, thereby converting the osmotic pressure of the saline water or brine into a hydrostatic pressure that can be used to produce electricity.

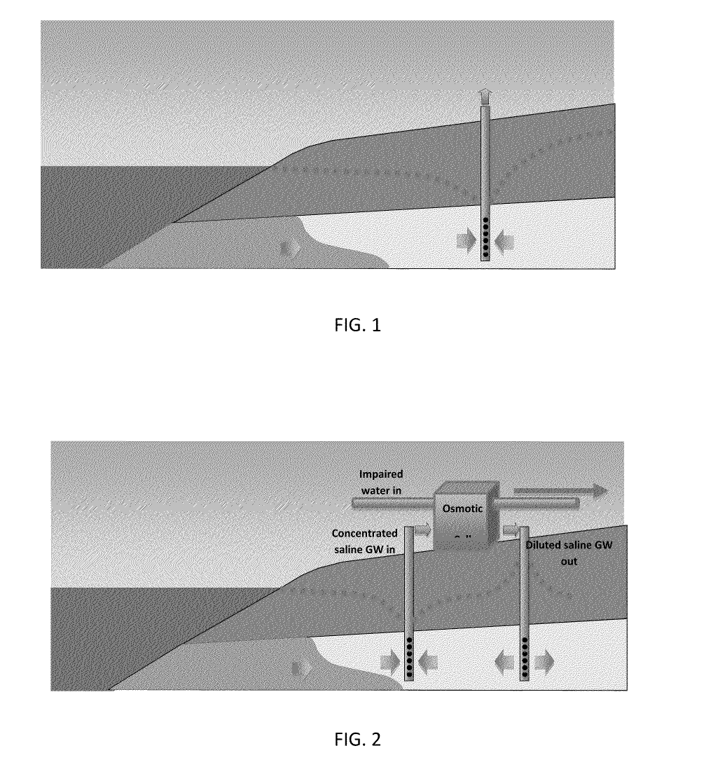

The process of saltwater intrusion is illustrated in FIG. 1. When groundwater is pumped at higher rates, saltwater flows into the aquifer, displacing fresh groundwater and changing its quality.

FIG. 2 illustrates an implementation of the method and system of the present disclosure. Although this implementation is applied to various groundwaters, the implementation can be adapted to other solutions and environments.

Salt water pumped from the aquifer has a suitably high osmotic pressure to induce spontaneous diffusion of water from a feed source through a semipermeable membrane. In some examples, the saline water flows under low pressure into an osmotic treatment process flowing on one side of the osmosis semipermeable membrane. At the surface, impaired water, such as raw wastewater, treated wastewater, brackish water, runoff water, or any potable or non-potable aqueous solution, flows into an osmotic treatment process, eventually flowing on the opposite side of the osmosis semipermeable membrane. Thus, the present disclosure can provide for sewer mining-extracting cleaner water resources from sources that might otherwise be considered waste. Water diffuses through the semipermeable osmosis membrane from the stream of impaired water into the saline groundwater. The saline groundwater is diluted while its volume increases.

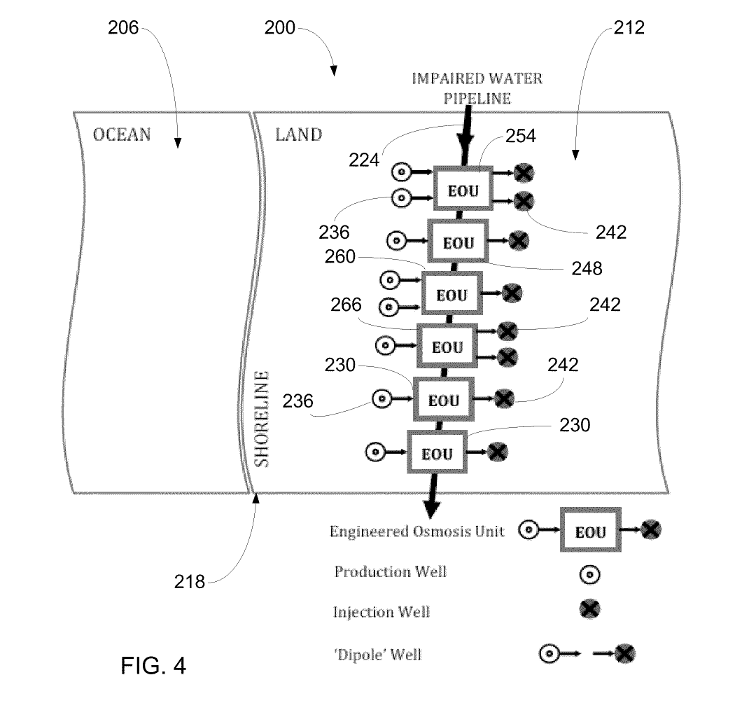

The osmotically diluted groundwater is injected inland from the extraction well to create an area of increased underground hydrostatic pressure of fresher water. The higher pressure inhibits the flow of saline water further inland, such as reducing or reversing inland flow. In some examples, the injection well is one of an array of ‘dipole’ wells used to establish an osmotic saltwater intrusion barrier. In some examples, the wells of the array are parallel to the shore or to the leading edge of intruding saltwater. Well arrays are further discussed below in conjunction with FIG. 4.

In some examples, the system and method are operated in PRO mode. PRO is used, in specific examples, to produce energy from the osmotic pressure difference between the impaired feed stream and the saline groundwater.

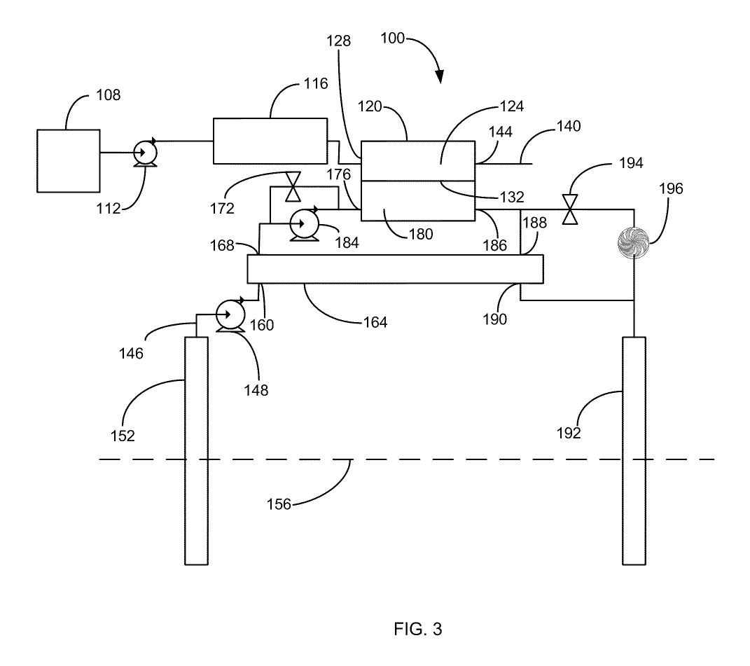

FIG. 3 presents a more detailed view of the system and method of FIG. 2, generally indicated as 100. Impaired water 108, such as raw wastewater, treated wastewater, brackish water, runoff water, or any potable or non-potable aqueous solution, is pumped using pump 112 into the feed side of the osmotic treatment process.

Depending on the quality of the impaired water 108, the impaired water 108 may optionally be pretreated using a pretreatment unit 116. Pretreatment may, for example, help protect a downstream osmosis unit 120 from contamination or fouling. Pretreatment unit 118 may carry out one or more pretreatment processes, such as treatment processes to remove inert or degradable constituents in the impaired water 108. In specific examples, the pretreatment processes are selected from conventional wastewater treatment processes, such as screening, clarification, biological processes, filtration, and combinations thereof. Pretreatment processes can also include membrane bioreactor processes or other membrane filtration processes.

The impaired water 108, optionally after passing through the pretreatment unit 116, is fed into the feed side 124 of the osmosis unit 120 through a feed inlet 128. In some examples, the impaired water 108 flows into the osmosis unit 120 under relatively low pressure. In one example, the osmosis unit 120 is an engineered osmosis unit, such as an engineered osmosis unit that includes a semipermeable membrane 132. Water diffuses from the impaired water 108 into a permeate side 136 of the osmosis unit 120. Impaired water 108 not passing through the membrane 132 exits as a concentrated impaired water stream 140 through a concentrated impaired water outlet 144. The concentrated impaired water stream 140, in some examples, is further treated.

A saline water stream 146, such as groundwater from an aquifer affected by saltwater intrusion, is pumped using a pump 148 from a production well 152 located closer to the source of saltwater. Pumping groundwater from the production well 152 creates drawdown of the water table 156.

In one implementation, the osmosis unit 120 is located on the surface and both the saline water stream 146 and the impaired water stream 108 flow through the osmosis unit 120. In another implementation, the osmosis unit 120 is submerged in the impaired water 108 and the saline water stream 146 flows inside tubular or framed membranes, for example. In a specific example, the osmosis unit is located in a sewer, water treatment facility, or similar source of impaired water.

The saline water stream 146 flows through the draw solution inlet 160 of a pressure exchanger 164, out through a draw solution outlet 168 of the pressure exchanger 164, through a valve 172, such as a pen valve, and through a draw solution inlet 176 of the osmosis unit 120 into a draw side 180 of the osmosis unit 120. In other implementations, the pressure exchanger 164 is located elsewhere in the system 100 or is omitted.

In operation, water from the impaired water 108 flows through the membrane 132 and into the saline water in the feed side 180 of the osmosis unit 120. Thus, the saline water is diluted with water from the impaired water 108. The semipermeable osmotic membrane 132 is typically selective and, when exhibiting this property, most contaminants in the impaired water stream are rejected and concentrated in the concentrated impaired water steam 140.

A diluted saline stream 187 flows out of the osmosis unit 120 unit through a product outlet 186 and into a product inlet 188 of the pressure exchanger 164, out of product outlet 190 of the pressure exchanger 164, and is injected into a recharge well 192, typically located inland from the production well 152. The pressure exchanger 164 can advantageously use the pressure of the stream from the production well 152 to inject diluted saline solution into the recharge well 192. In examples where the pressure exchanger 164 is omitted, the diluted saline stream 187 can flow out of the product outlet 186 and into the recharge well 192. In these examples, a pump or other pressurizing means can be used to inject water into the recharge well. The diluted saline water 187 induces higher hydraulic head in the aquifer and reduces or prevents further intrusion of saline water into the aquifer.

Under specific conditions, the osmotic intrusion barrier process is operated in a pressure retarded osmosis (PRO) mode and conducts the same task of diluting saline groundwater, but with the additional benefit of producing energy. Under these conditions the impaired feed water 108 is treated as described above in the feed side of the process 100. In such, the system 100 can include a booster pump 184 coupled between the draw solution outlet 168 and the draw solution inlet 176. In PRO mode, the salt side 180 of the osmosis unit 120 is pressurized by water diffusion through the osmotic membrane 132. A portion of the pressurized diluted saltwater flows through a valve 194 into a generator 196, such as a turbogenerator, and another portion flows through the pressure exchanger 164 and electricity of mechanical work is generated. A combined depressurized diluted saline stream is then injected into the recharge well 192. In other implementations, the booster pump 184 and/or generator 196 are omitted or located elsewhere in the system 100.

FIG. 4 illustrates a system 200 having a plurality of production wells and a plurality of recharge wells. A saline body of water 206, such as an ocean, is separated from an inland portion 212 by a shoreline 218. The inland portion includes one or more feed water source 224, such as a pipeline of impaired water, such as waste water.

A plurality of osmosis units 230, such as engineered osmosis units, are coupled to the feed water source 224. Each osmosis unit 230 is fluidly coupled to one or more production wells 236 and recharge wells 242. The recharge wells 242 are typically located upstream, that is, more inland, from the production wells 236. The combination of a coupled production well 236 and recharge well 242 may be referred to as a “dipole well.”

In some cases, an osmosis unit 248 is coupled to a single production well 236 and a single recharge well 242. In other implementations, a plurality of production wells 236 and a plurality of recharge wells 242 are coupled to an osmosis unit 254. In yet another implementation, an osmosis unit 260 is coupled to a plurality of production wells 236 and a single recharge well 242. In another implementation, an osmosis unit 266 is coupled to a single production well 236 and a plurality of recharge wells 242.

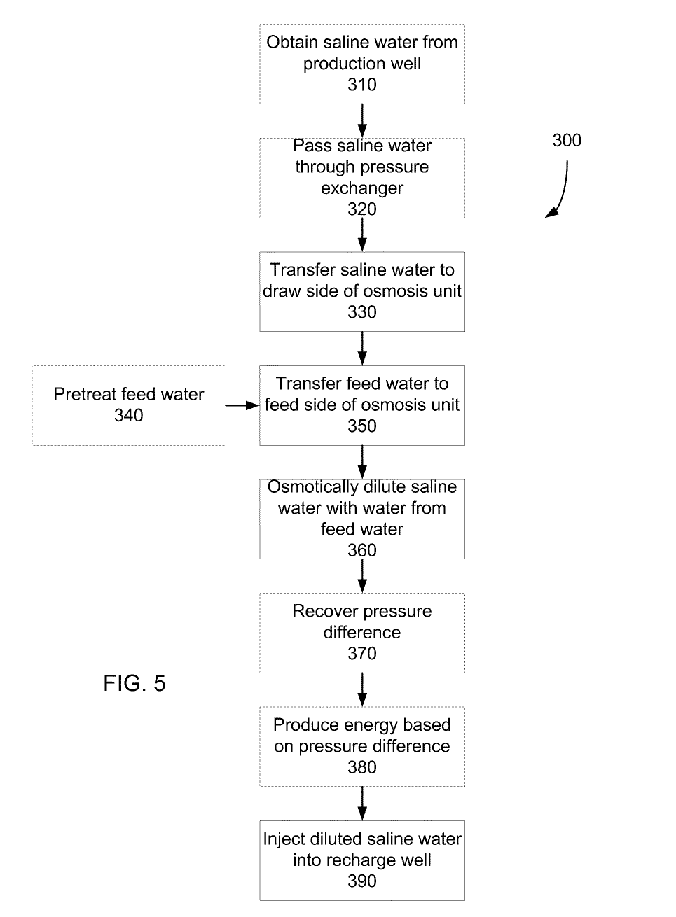

FIG. 5 illustrates a method 300 of operating a system according to an embodiment of the present disclosure, such as using system 100 of FIG. 3 or system 200 of FIG. 4. Saline water is obtained, such as by pumping, from a production well in step 310. In optional step 320, the saline water is passed through a pressure exchanger. In step 330, saline water from step 310 or 320 is transferred to the draw side of an osmosis unit, such as an engineered osmosis unit.

Feed water is pretreated in optional step 340. In step 350, feed water from step 340 or from another source, is transferred to the feed side of the osmosis unit. In a specific example, the feed water is impaired water, such as waste water. The saline water is osmotically diluted in the osmosis unit with water from the feed water.

Pressure from a pressure exchanger is transferred to the diluted saline solution in optional step 370, increasing the pressure of the diluted saline solution. Step 370 is, in some examples, coupled with optional step 320. Transferring pressure to the diluted saline solution using the pressure exchanger can allow the diluted saline solution to be injected into a recharge well without additional energy or pumping, or at a reduced level of energy or pumping. In some implementations of the method 300, energy is produced in optional step 380 from pressure recovered in steps 320 and/or 370. The diluted water, from step 380 or 360, is provided to a recharge well in step 390.

The disclosed method and system can provide a number of advantages. Impaired water can be treated at the injection site, close to the location where the impaired water is generated, which can reduce treatment and transport costs. The present disclosure provides a high-level treatment in a one step, low energy process that takes advantage of the osmotic pressure energy in the saline groundwater, low fouling of osmotic membranes, the opportunity to further recover energy in PRO, and the volume reduction of wastewater that needs to be transferred to a wastewater treatment plant, thus reducing infrastructure costs.

It is to be understood that the above discussion provides a detailed description of various embodiments. The above descriptions will enable those skilled in the art to make many departures from the particular examples described above to provide apparatuses constructed in accordance with the present disclosure. The embodiments are illustrative, and not intended to limit the scope of the present disclosure. The scope of the present disclosure is rather to be determined by the scope of the claims as issued and equivalents thereto.

What is claimed is:

1. A osmotic barrier system comprising:
a production well;
a production pump coupled to the production well;
a pressure exchanger having a draw solution inlet, a draw solution outlet, a product solution inlet, and a product solution outlet, the draw solution inlet coupled to the production pump;
an impaired water source;
an osmosis unit having a feed inlet, a feed outlet, a draw solution inlet, and a product solution outlet, the feed inlet being coupled to the impaired water source, the draw solution inlet being coupled to the draw solution outlet of the pressure exchanger, and the product solution outlet being coupled to the product solution inlet of the pressure exchanger; and
a recharge well coupled to the product solution outlet of the osmosis unit.

2. The osmotic barrier system of claim 1, wherein the production recharge well is one of an array of recharge wells.

3. The osmotic barrier system of claim 2, wherein the array of recharge wells are located parallel to a shoreline or a saltwater incursion front.

4. The osmotic barrier system of claim 1, further comprising a generator coupled to the recharge well and the product solution outlet of the osmosis unit.

5. The osmotic barrier system of claim 1, further comprising a pretreatment unit situated between the impaired water source and the osmosis unit.

6. The osmotic barrier system of claim 4, further comprising a booster pump coupled between the draw solution outlet of the pressure exchanger and the draw solution inlet of the osmosis unit.

7. A method of forming an osmotic barrier comprising:
pumping a saline solution from a production well;
passing the saline solution through a pressure exchanger;
transferring the saline solution to a draw solution side of an osmosis unit;
passing an impaired water into the feed solution side of the osmosis unit;
osmotically diluting the saline solution with water from the impaired water to form a diluted saline solution;
transferring at least a portion of the diluted saline solution through the pressure exchanger; and
transferring the diluted saline solution to a recharge well.

8. The method of claim 7, further comprising generating electricity from the diluted saline solution.

9. The method of claim 8, further comprising passing at least a portion of the diluted saline solution through a generator.

10. The method of claim 7, further comprising pretreating the impaired water.

11. A osmotic barrier system comprising:
a production well providing a saline solution;
a feed water source;
an engineered osmosis unit fluidly coupled to the feed water source and the production well; and
a recharge well fluidly coupled to the engineered osmosis unit, wherein the engineered osmosis unit dilutes the saline solution with water from the feed water source and provides a diluted saline solution to the recharge well.

12. The osmotic barrier system of claim 11, wherein the feed water source comprises impaired water.

13. The osmotic barrier system of claim 11, wherein the production well is a first production well of a plurality of production wells and a second production well is coupled to the engineered osmosis unit.

14. The osmotic barrier system of claim 11, wherein the recharge well is a first recharge well of a plurality of recharge wells and a second recharge well is coupled to the engineered osmosis unit.

15. The osmotic barrier system of claim 13, wherein the recharge well is a first recharge well of a plurality of recharge wells and a second recharge well is coupled to the engineered osmosis unit.
